(19) United States
(12) Patent Application Publication
(10) Pub. No.: US 2011/0030026 A1
(43) Pub. Date: Feb. 3, 2011

(54) DIGITAL BROADCAST TRANSMITTER AND RECEIVER AND METHOD FOR TRANSMITTING AND RECEIVING BROADCAST THEREOF

(75) Inventors: Ga-hyun Ryu, Suwon-si (KR); June-hee Lee, Seongnam-si (KR); Sung-il Park, Suwon-si (KR); Jong-hwa Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/844,467

(22) Filed: Jul. 27, 2010

(30) Foreign Application Priority Data
Jul. 28, 2009 (KR) 10-2009-0068910

(51) Int. Cl. H04N 7/173

(52) U.S. Cl. 725/131

(57) ABSTRACT

A digital broadcast receiver is provided. The receiver includes a reception unit to select an aggregation channel providing access information regarding at least one broadcast channel and a control unit to control the reception unit to select a broadcast channel using access information provided by the aggregation channel.

### CROSS-REFERENCE TO RELATED APPLICATIONS

This application claims priority from Korean Patent Application No. 10-2009-68910, filed in the Korean Intellectual Property Office on Jul. 28, 2009, the disclosure of which is incorporated herein by reference in its entirety.

### BACKGROUND

1. Field

The disclosed embodiments relate to a digital broadcast transmitter and receiver and a method for transmitting and receiving broadcast thereof, and more particularly, to a digital broadcast transmitter and receiver using an aggregation channel and a method for transmitting and receiving broadcast thereof.

2. Description of the Related Art

With the development of digital technology, a digital processing system of an image area such as a digital television, is already used. Accordingly, various digital broadcast standards have been introduced to allow digital broadcast data to be received and processed at home.

In the case of digital broadcast in the United States, terrestrial broadcast uses an Advanced Television Systems Committee (ATSC) A. 53 (8-VSB) broadcast standard, and a cable broadcast uses an ITU-T J.83 (QAM type) broadcast standard.

Digital broadcast is advantageous because it can provide a broadcast with high definition, because it has a great efficiency of transmitting an electric wave compared to an analog broadcast, and because it can transmit and receive more information than any other broadcast. However, digital broadcast may be interrupted when its transmission stream is broken due to magnetic fields or other obstacles in the vicinity.

This problem is more severe with various mobile devices such as a cellular phone, a personal digital assistant (PDA), a personal music player (PMP), and an MP3 player, which have been broadly used in recent years. There are many discussions regarding the standards of digital broadcast using mobile devices.

Accordingly, there is a need for a receiver to receive only a specific broadcast among cable broadcast, terrestrial broadcast and ATSC broadcast following an ATSC M/H broadcast standard. In addition, a receiver to search a specific broadcast, particularly ATSC broadcast, a method for receiving the broadcast, a transmitter for ATSC broadcast, and a method for transmitting the broadcast, are required.

### SUMMARY

One or more exemplary embodiments relate to a digital broadcast transmitter and receiver that search for an ATSC mobile TV channel from overall broadcast channels using an aggregation channel and a method for transmitting and receiving the broadcast. In this case, a search for an ATSC broadcast channel may be performed.

According to an aspect of an exemplary embodiment, there is provided a digital broadcast receiver which has a reception unit which selects an aggregation channel providing access information regarding at least one broadcast channel and a control unit which controls the reception unit to select a broadcast channel from the at least one broadcast channel using access information provided by the aggregation channel.

The access information may be mapping information which maps information representing the broadcast channel to at least one physical frequency information accessible to the broadcast channel.

The information representing the broadcast channel may be at least one of a logo, a broadcast channel number, and a broadcast channel name.

The aggregation channel may be a predetermined channel having the same broadcast channel name in each region.

The control unit may control the reception unit to scan available broadcast channels until the aggregation channel is identified and to select the broadcast channel using the access information provided by the identified aggregation channel.

The control unit may read information that the broadcast channel is the aggregation channel from a predefined area of a transmission stream and confirm the aggregation channel.

The control unit may read information that another broadcast channel indicated by the broadcast channel is the aggregation channel from a predefined area of a transmission stream and confirm the aggregation channel.

The digital broadcast receiver may further include n a storage unit which stores an aggregation channel having a different broadcast channel number for each region, and the control unit may access an aggregation channel corresponding to a region using the stored aggregation channel number and control the reception unit to select a broadcast channel using access information of the aggregation channel.

The control unit may update an aggregation channel for the region or the access information if it is determined that the aggregation channel for the region or the access information is changed.

The control unit may read information regarding whether an update has been performed from a predefined area of a transmission stream through which the aggregation channel is transmitted, and update the aggregation channel or the access information.

The digital broadcast receiver may further include a display unit to display information representing the broadcast channel.

If the digital broadcast receiver is turned on, or if a handover of the digital broadcast receiver occurs, the reception unit may select the aggregation channel if a user inputs a command to select an aggregation channel.

The digital broadcast receiver may further include a demodulation unit to demodulate a transmission stream received through the selected broadcast channel, an equalizer to equalize the demodulated transmission stream, and a decoding unit to decode the equalized transmission stream.

The control unit may identify access information provided by the aggregation channel through the decoded transmission stream.

According to an aspect of another exemplary embodiment, there is provided a receiving method of a digital broadcast receiver. The method including selecting an aggregation channel providing access information regarding at least one broadcast channel and controlling broadcast channel selection so that a broadcast channel is selected using access information provided by the aggregation channel.

The access information may be mapping information that maps information representing a broadcast channel to at least one physical frequency information accessible to the broadcast channel.

The information representing a broadcast channel may be at least one of a logo, a broadcast channel number, and a broadcast channel name.

The aggregation channel may be a channel that is preset to have the same broadcast channel number in each region.

The controlling broadcast channel selection may scan available broadcast channels, stops scanning if the aggregation channel is identified, and select a broadcast channel using access information provided by the identified aggregation channel.

The controlling broadcast channel selection may read information that a broadcast channel is an aggregation channel from a predefined area of a transmission stream, and confirm the aggregation channel.

The controlling may read information that a broadcast channel indicated by a broadcast channel is an aggregation channel from a predefined area of a transmission stream, and confirms the aggregation channel.

The receiving method of a digital broadcast receiver may further include storing an aggregation channel having a different broadcast channel for each region, and the controlling broadcast channel selection may access an aggregation channel corresponding to a region using the stored aggregation channel number, and select a broadcast channel using access information of the aggregation channel.

The controlling broadcast channel selection may update an aggregation channel for the region or the access information if it is determined that an aggregation channel for the region or the access information is changed.

The controlling may read information regarding whether an update has been performed from a predefined area of a transmission stream, and update the aggregation channel or the access information.

The receiving method of a digital broadcast receiver may further include displaying information representing the broadcast channel.

The receiving may select the aggregation channel if a user inputs a command to select an aggregation channel, if the digital broadcast receiver is turned on, or if a handover of the digital broadcast receiver occurs.

The receiving method of a digital broadcast receiver may further include demodulating a transmission stream received through the selected broadcast channel, equalizing the demodulated transmission stream, and decoding the equalized transmission stream.

The controlling broadcast channel selection may identify access information provided by the aggregation channel through the decoded transmission stream.

### BRIEF DESCRIPTION OF THE DRAWINGS

The above and/or other aspects will become apparent and more readily appreciated from the following description of exemplary embodiments, taken in conjunction with the accompanying drawings, of which:

FIG. 1 is a view illustrating a digital broadcast transmitter according to an exemplary embodiment;

FIG. 2 is a view illustrating an example of an additional data processing unit according to an exemplary embodiment;

FIG. 3A is a view illustrating an example of a transmission stream applicable to a general digital broadcast transmitter according to an exemplary embodiment, and FIG. 3B is a view illustrating an example of a transmission stream applicable to a digital broadcast transmitter according to an exemplary embodiment;

FIG. 4A is a chart illustrating various parameters of TPC data according to an exemplary embodiment, FIGS. 4B and 4C are charts illustrating various parameters of FIC data according to an exemplary embodiment, and FIG. 4D is a view illustrating a field sync and a segment sync of a transmission stream according to an exemplary embodiment;

FIG. 5 is a flow chart illustrating a transmission method of a digital broadcast transmitter according to an exemplary embodiment;

FIG. 6 is a view illustrating a digital broadcast receiver according to an exemplary embodiment;

FIG. 7 is a view illustrating a digital broadcast receiver of FIG. 6 in greater detail according to an exemplary embodiment;

FIG. 8 is a view illustrating a digital broadcast receiver of FIG. 7 in greater detail according to an exemplary embodiment; and

FIG. 9 is a flow chart illustrating a receiving method of a digital broadcast receiver according to an exemplary embodiment.

### DETAILED DESCRIPTION OF EXEMPLARY EMBODIMENTS

Reference will now be made in detail to the exemplary embodiments, examples of which are illustrated in the accompanying drawings, wherein like reference numerals refer to like elements throughout. The exemplary embodiments are described below with reference to the figures.

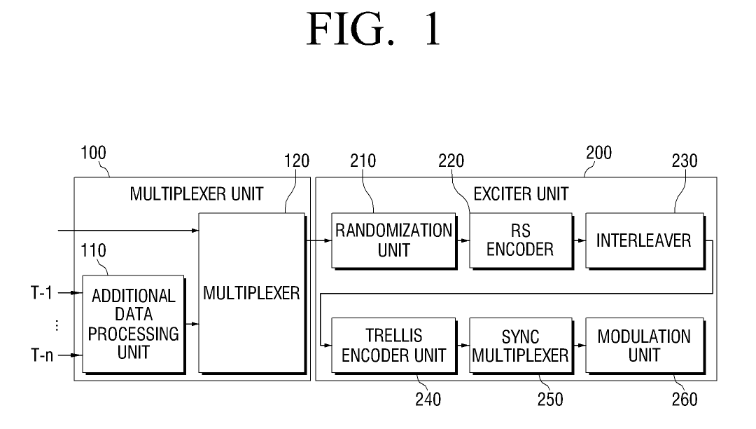

FIG. 1 is a view illustrating a digital broadcast transmitter according to an exemplary embodiment. The digital broadcast transmitter includes a multiplexer unit 100, and an exciter unit 200. The multiplexer unit 100 may include an additional data processing unit 110 and a multiplexer 120. In addition, the exciter unit 200 may include a randomization unit 210, an RS encoder 220, an interleaver 230, a trellis encoder unit 240, a sync multiplexer 250, and a modulation unit 260.

Specifically, the digital broadcast transmitter includes the additional data processing unit 110 to process an additional data stream so that it is robust against errors, the multiplexer 120 to generate a transmission stream by multiplexing the processed additional data stream with access information regarding at least one broadcast channel, the randomization unit 210 to randomize the generated transmission stream, the RS encoder 220 to Reed-Solomon encode the randomized transmission stream, the interleaver 230 to interleave the encoded transmission stream, the trellis encoder unit 240 to trellis-encode the interleaved transmission stream, the sync multiplexer 250 to insert a field sync and a segment sync into the trellis encoded transmission stream, and the modulation unit 260 to modulate the transmission stream with the inserted field sync and segment sync.

The access information may be mapping information which maps information representing a broadcast channel to information regarding at least one physical frequency accessible to the broadcast channel.

In this case, the information representing a broadcast channel may be at least one of a logo, a broadcast channel number, and a broadcast channel name.

The additional data stream represents a stream which is specifically processed to be robust against errors. For instance, the additional data stream may be a stream which is processed to be robust against errors in a mobile device by applying a coding method or a coding rate different from that of a regular data stream.

The multiplexer 120 may generate a transmission stream by multiplexing a regular data stream, an additional data stream, and access information regarding at least one broadcast channel.

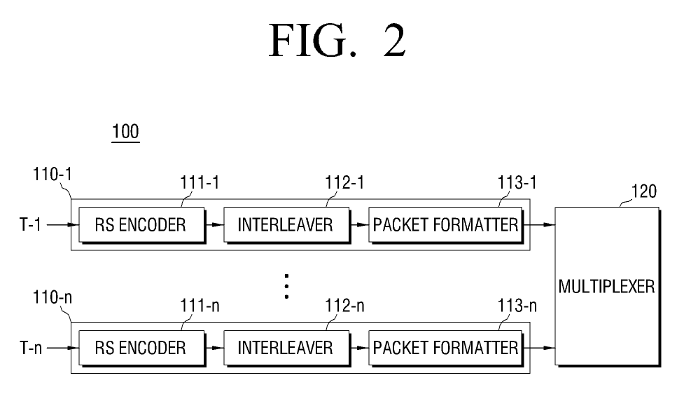

FIG. 2 is a view illustrating an example of an additional data processing unit according to an exemplary embodiment.

The additional data processing unit 110 processes at least one additional data stream, and may include an RS encoder 111-1, an interleaver 112-1, and a packet formatter 113-1, as illustrated in FIG. 2. Accordingly, the additional data processing unit 110 may process the data stream T-1 to T-n provided by an internal or an external source to be robust against errors and provide the processed data stream T-1 to T-n to the multiplexer 120.

The digital broadcast transmitter according to an exemplary embodiment may further include a known data insertion unit which inserts known data or a training sequence into a transmission stream (not shown). The known data represents data known to both a transmitter and a receiver, and if it is transmitted after being inserted into a transmission stream, a receiver may check the received known data and use it for demodulation or equalization, enhancing reception performance.

If the known data is inserted, the trellis encoder unit 240 may perform trellis resetting at an appropriate point of time. That is, the trellis encoder unit 240 may use a plurality of internal memories (for instance, 3 shift registers) during a trellis encoding process. When trellis encoding is performed on the known data, the value of the know data may be changed to previous values stored in the internal memories. In order to prevent this, it is better to reset the internal memories to their initial values before the known data is processed. In order to prevent parity from being distorted in response the trellis resetting being performed, parity correction may be performed. In this case, such a component as an RS encoder (not shown) may be added.

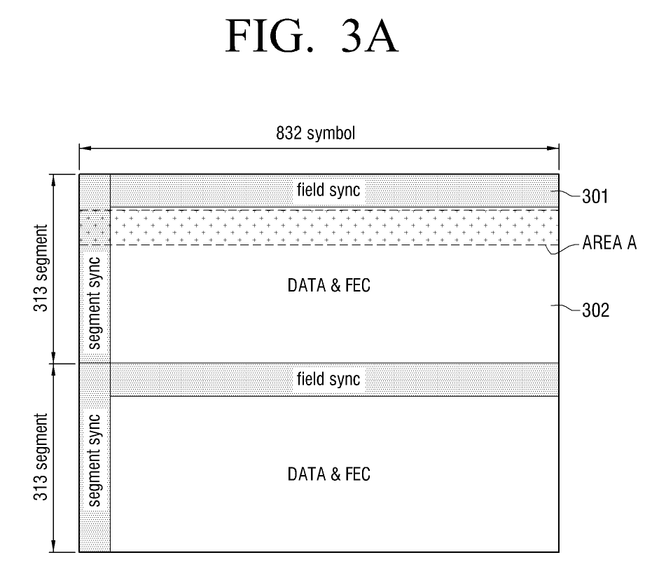

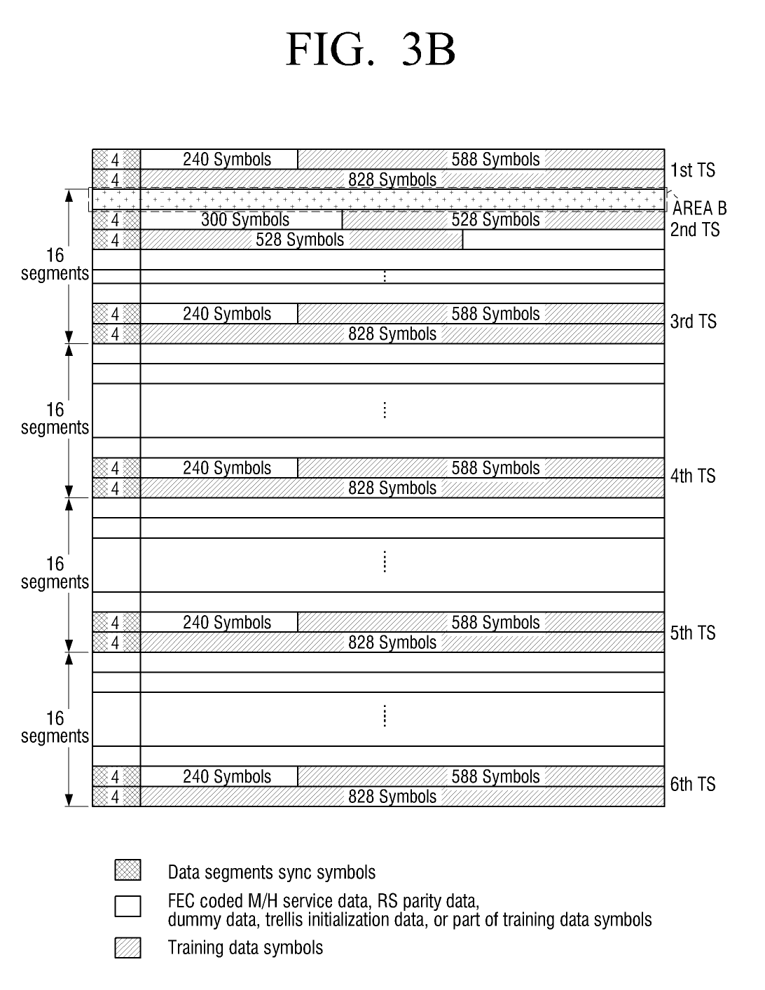

FIG. 3A is a view illustrating an example of a transmission stream transmitted by a general digital broadcast transmitter according to an exemplary embodiment, and FIG. 3B is a view illustrating an example of another transmission stream transmitted by the digital broadcast transmitter according to an exemplary embodiment.

Referring to FIG. 3A, one transmission frame comprises 2 fields, each 313 segments. A first field may comprise a first field sync area 301 which is the first segment called a field sync segment and 312 data areas 302 called a data segment. In other words, a frame may have a structure in which another field sync packet (Area A) is added to each packet group comprising 312 packets. On the other hand, one segment which is one packet may comprise a total of 832 symbols, a segment sync signal of 4 symbols and 828 data symbols.

FIG. 3B is a view illustrating an example of a transmission stream transmitted by the digital broadcast transmitter according to an exemplary embodiment, and may comply with an ATSC-M/H standard of the United States. The transmission stream may be a transmission stream in which an additional data stream processed to be robust against errors is inserted into the data area (DATA & FEC area) of the transmission stream as illustrated in FIG. 3A, or a transmission stream in which an additional data stream is inserted along with a known data (training sequence). Specifically, in FIG. 3B, 6 training sequences (TS) are inserted into the data area of the transmission stream, and various other information may be inserted into a blank area of the data area of the transmission stream along with the additional data stream. Signaling data (or information data) such as transmission parameter channel (TPC) data and fast information channel (FIC) data may be included in the B area between the first TS and the second TS.

An additional data stream and a regular data stream may be alternately positioned in a blank area of the data area of the transmission stream along with various other information.

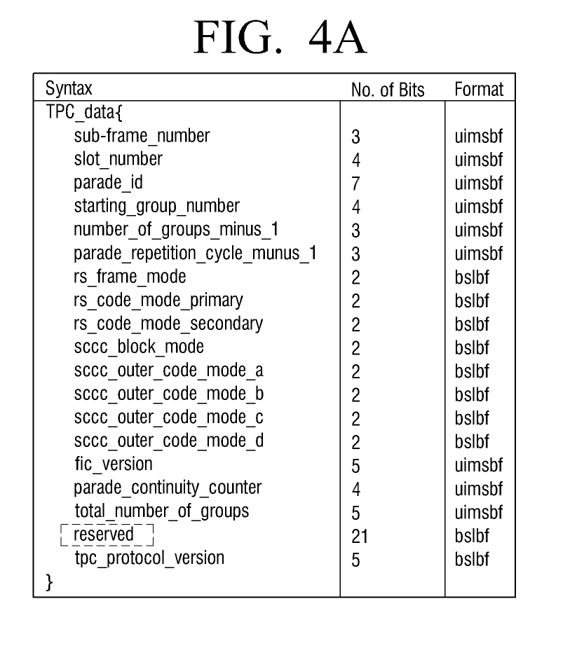

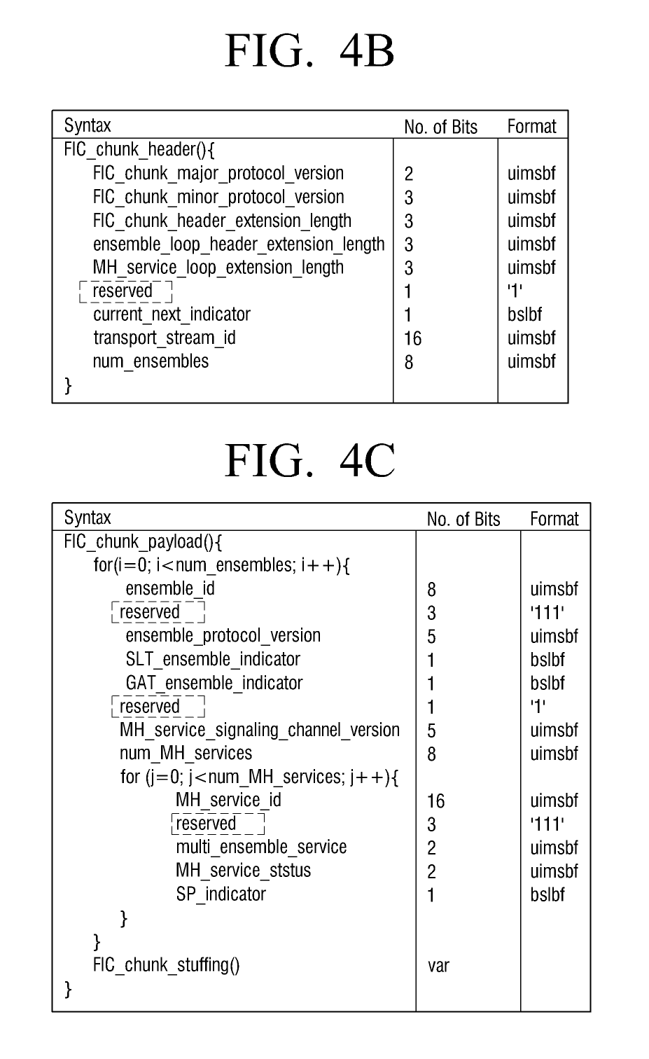

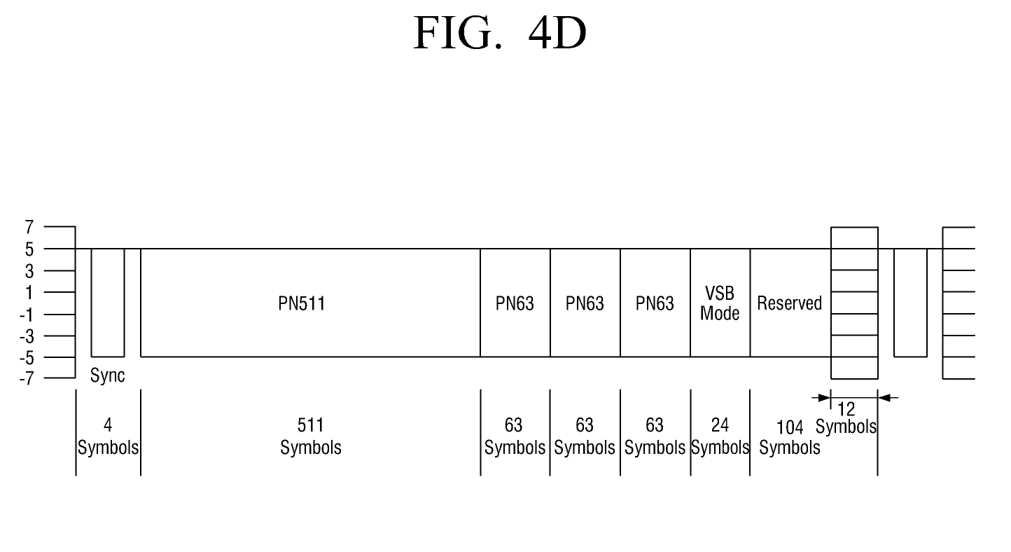

FIG. 4A is a chart illustrating various parameters of TPC data according to an exemplary embodiment, FIGS. 4B and 4C are charts illustrating various parameters of FIC data according to an exemplary embodiment, and FIG. 4D is a view illustrating a field sync and a segment sync of a transmission stream according to an exemplary embodiment.

Referring to FIG. 4A, the TPC data is signaling data, and may represent data of various parameters used for a physical layer. Specifically, the TPC data may be data indicating a location of the additional data stream in the transmission stream. In this case, access information of a broadcast channel may be inserted into and located in a “reserved” area of the TPC data.

Referring to FIGS. 4B and 4C, the FIC data is signaling data and may represent data of various parameters used for a layer higher than the physical layer. Specifically, the FIC data may be data providing bibliographic information regarding at least one group comprising an additional data stream and at least one service included in each of a plurality of groups. In this case, access information of a broadcast channel may be inserted into a “reserved” area of the header of the FIC data as shown in FIG. 4B, or may be inserted into a “reserved” area of at least one payload of the FIC data as shown in FIG. 4C.

FIG. 4D is a view illustrating a segment sync and a field sync of a transmission stream according to an exemplary embodiment. The segment sync and the field sync include a segment sync comprising 4 symbols, a pseudo noise sequence (PN) comprising 511 symbols, 3 PN sequences comprising 63 symbols, a VSB mode comprising 24 symbols, and a reserved area comprising 104 symbols. In this case, access information of a broadcast channel may be inserted into the reserved area of the field sync.

The TPC data, the FIC data, and the reserved area which is predefined area of the field sync may include not only the access information of a broadcast channel but also information regarding a broadcast channel or information regarding various services of a broadcast channel. Specifically, they may include information regarding various services of a broadcast channel, information indicating that a specific broadcast channel is an aggregation channel, information indicating that a broadcast channel referred to by the specific broadcast channel is an aggregation channel, and information regarding whether update has been performed. Detailed exemplary description is provided below.

According to an exemplary embodiment, access information of a broadcast channel may be inserted into various other areas, unlike in an exemplary embodiment described with reference to FIGS. 4A to 4D.

If access information of a broadcast channel included in at least one of the TPC data, the FIC data, a predefined area of a field sync, or a reserved area is encoded by a transmitter and transmitted to a receiver, the receiver may use the access information of the broadcast channel by decoding at least one data of the TPC data, the FIC data, and data included in the reserved area of the field sync.

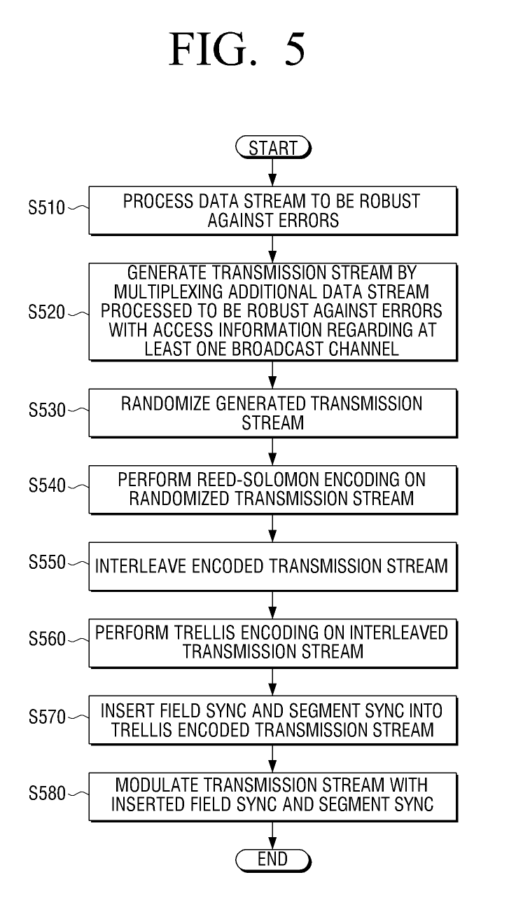

FIG. 5 is a flow chart illustrating a transmission method executed by a digital broadcast transmitter according to an exemplary embodiment. Referring to FIG. 5, the transmission method includes processing an additional data stream to be robust against errors (S510), generating a transmission stream by multiplexing the additional data stream processed to be robust against errors with access information of at least one broadcast channel (S520), randomizing the generated transmission stream (S530), perform Reed-Solomon encoding on the randomized transmission stream (S540), interleaving the encoded transmission stream (S550), perform trellis encoding on the interleaved transmission stream (S560), inserting a field sync and a segment sync into the trellis encoded transmission stream (S570), and modulating the transmission stream with the inserted field sync and segment sync (S580).

The access information may be mapping information which maps representative information symbolizing a channel to information regarding at least one physical frequency accessible to the channel.

In this case, the representative information symbolizing a channel may be at least one of a logo, a channel number, and a channel name.

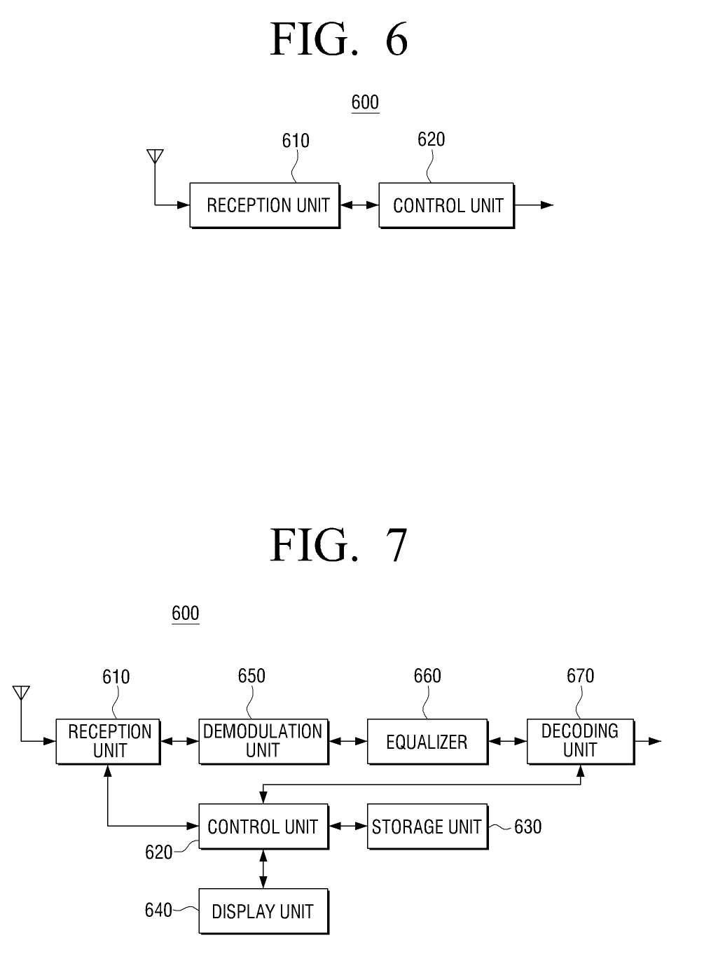

FIG. 6 is a view illustrating a digital broadcast receiver according to an exemplary embodiment. Referring to FIG. 6, a digital broadcast receiver 600 comprises a reception unit 610 and a control unit 620.

The reception unit 610 selects an aggregation channel which provides access information of at least one broadcast channel. The reception unit 610 may include a down converter (not shown) to convert an analog signal received from an antenna to a digital signal, an AD converter (not shown), and a tuner to select a desired broadcast channel.

The control unit 620 controls the reception unit 610 to select a broadcast channel using the access information provided by the aggregation channel.

The reception unit 610 may select an aggregation channel according to one of preset events. In this case, if a user command to select an aggregation channel is input and if the digital broadcast receiver 600 is turned on or if a handover occurs as the digital broadcast receiver 600 moves from a specific cell to another cell, a preset event may occur.

In this case, the channel may be a physical broadcast channel providing specific broadcast content (or service), and may be a channel with a virtually designated channel number such as 11-1, 11-2, or 11-3. In addition, the broadcast channel may be a mobile broadcast channel following an ATSC-M/H broadcast standard of the United States, that is an ATSC Mobile TV broadcast channel, or an ATSC broadcast channel.

The aggregation channel may be a channel to provide access information of a broadcast channel. The aggregation channel may exist in a different frequency band depending on a region, or may exist in a specific frequency band that a transmitter and a receiver agree upon. In addition, not only data providing access information of at least one broadcast channel but also actual broadcast contents (or services) may be transmitted to the frequency band where the aggregation channel exists. Other than the above-described access information and actual broadcast contents, various services of a broadcast channel may be included in the frequency band where the aggregation channel exists.

The access information of a broadcast channel may be mapping information which maps information representing a broadcast channel to information regarding at least one physical frequency accessible to the broadcast channel. In particular, the mapping information is disposed in a predefined area of the TPC data as placed by a transmitter, packetized in a mapping table format along with a transmission stream, and a receiver may receive the mapping information.

The physical frequency information may be replaced with an identifier corresponding to the physical frequency, and the mapping information may be pre-stored in the digital broadcast receiver 600 or pre-received through a broadcast channel and stored.

In this case, the information representing a broadcast channel may be at least one of a logo, a broadcast channel number, and a broadcast channel name. The logo may be a logo of a broadcast provider such as a logo of ABC broadcasting company, and may be a logo representing a specific broadcast (program) by a specific broadcast provider such as LOST, the drama. In addition, the information representing a broadcast channel may be a GUI or various other information in a text format as long as it can be mapped with a physical frequency.

In an exemplary embodiment, if there exists frequency channel numbers from 1 to 200 broadcast in a specific area, those frequency channel numbers may include terrestrial broadcast, cable broadcast, and ATSC broadcast. In this case, an aggregation channel may exist in at least one broadcast channel from overall broadcast channels. If an aggregation channel exists in channel 61 for example, a user may receive access information regarding the overall broadcast channels through the aggregation channel without searching all frequency channel numbers from 1 to 200, and thus, there is no need to scan the channels.

The digital broadcast receiver 600, according to an exemplary embodiment, may be realized in a single chip, a mobile terminal such as a mobile phone, a navigation system, an MP3 player, and a PMP player, a broadcast reception apparatus such as a desktop PC and a TV, or a set-top box.

FIG. 7 is a view illustrating an example of a digital broadcast receiver in FIG. 6 in detail, according to an exemplary embodiment. Referring to FIG. 7, the digital broadcast receiver 600 may further include a storage unit 630, a display unit 640, a demodulation unit 650, an equalizer 660, and a decoding unit 670 in addition to the reception unit 610 and the control unit 620.

The digital broadcast receiver in FIG. 6 or FIG. 7 may operate in various ways according to exemplary embodiments.

According to a first exemplary embodiment, the storage unit 630 may store an aggregation channel having different broadcast channels depending on a region. For instance, the storage unit 630 may store information that an aggregation channel in LA is channel 61, an aggregation channel in Washington is channel 51, and an aggregation channel in Utah is channel 27. Of course, the storage unit 630 may also store access information regarding a broadcast channel provided by the aggregation channel. The broadcast channels may be determined by a frequency band used by a provider which provides broadcast channel information in each region. Herein, the scope of a region may be by city, county, or etc.

In this case, the storage unit 630 identifies a region where the digital broadcast receiver 600 is currently located, and reads out aggregation channel information corresponding to the region from the storage unit 630. The region may be identified in various ways such as using GPS information, information in a broadcast stream, or a user may directly input the region.

The control unit 620 controls the reception unit 610 to select an aggregation channel corresponding to the current region using the above-mentioned information. Accordingly, the reception unit 610 receives a stream through the selected channel, that is the aggregation channel, and the demodulation unit 650, the equalizer 660, and the decoding unit 670 recovers the broadcast channel by sequentially processing the received stream. The control unit 620 displays information representing the broadcast channel on the display unit 640 so that a user may select a desired broadcast channel.

According to a first exemplary embodiment, an aggregation channel or access information of a specific region may be changed. If it is determined that an aggregation channel or access information of a specific region is changed, the provider may update the aggregation channel for the region.

For instance, if the aggregation channel used in a region A is changed from channel 11 to channel 27, a handover occurs in the digital broadcast receiver 600, and thus the previous aggregation channel 11 does not exist even if the reception unit 610 searches for the aggregation channel stored in the storage 630 because the channel 11 is no longer the aggregation channel. Accordingly, the control unit 620 determines that an aggregation channel or access information for the region is changed and may update the aggregation channel for the region stored in the storage unit 630. The aggregation channel may be updated while the aggregation channel is directly scanned in the region or using a memory element such as a USB.

New aggregation channel 27 may be added to the aggregation channel 11 used in region A. In an exemplary embodiment, it is impossible to determine whether an update is needed using the above-mentioned method.

Accordingly, an aggregation channel may be updated by determining whether it is necessary to update the digital broadcast receiver 600 using update information included in a predefined area of the transmission stream which includes the stored aggregation channel. Herein, the update information may be version information that has an expiration date for the aggregation channel. According to an exemplary embodiment, an aggregation channel including information regarding whether to perform an update, in addition to access information of a broadcast channel, may be stored in the storage unit 630.

If a specific event (for example, accessing wireless Internet or inputting a specific key value) occurs, update can be performed directly without determining whether the aggregation channel stored in the digital broadcast receiver 600 needs to be updated.

According to a second exemplary embodiment, the storage unit 630 may set a predetermined aggregation channel so that every region has the same broadcast channel number. Herein, the aggregation channel may be a channel in which a specific channel number or a specific channel frequency is preset to be the same for a transmitter and a receiver.

If a broadcast station using a specific frequency band exists in each region and broadcast channels are provided through a frequency band from the broadcast station, the control unit 620 may control the reception unit 610 using aggregation channel information preset in the storage unit 630 if a specific event occurs such as the digital broadcast receiver 600 is turned on or a user requests to watch a broadcast. Specifically, an aggregation channel may be set as the default and embedded in the digital broadcast receiver 600. The stream received through the broadcast channel selected by the reception unit 610 may be processed according to the first exemplary embodiment, and provided to a user. Even if the digital broadcast receiver 600 is an exclusive terminal which receives broadcast only from a specific broadcast provider, it may operate according to the second exemplary embodiment. In order to operate as detailed in the second exemplary embodiment, other broadcast providers providing ATSC broadcast may obtain permission from a specific broadcast provider or may have arrangements with the specific broadcast provider to provide the ATSC broadcast channel information of the broadcast providers to the aggregation channel of the specific broadcast provider.

According to a third exemplary embodiment, the control unit 620 may instruct the reception unit 610 to search for an aggregation channel through scanning. That is, if a specific event occurs such as the digital broadcast receiver 600 is turned on or a user requests to watch a broadcast, the control unit 620 sequentially scans valid channels in the region. The order of scanning may be arbitrarily. For instance, channels may be scanned automatically from the lowest channels to the highest channels or from the highest channels to the lowest channels.

The control unit 620 may check an aggregation channel by reading information that the broadcast channel is an aggregation channel from a predefined area of the transmission stream received through the broadcast channel. For instance, if the broadcast channel is channel 11, the predefined area of the transmission stream received through the broadcast channel may store information that the channel number 11 is an aggregation channel. Accordingly, the control unit 620 may read the information received from the broadcast channel 11 and confirm that the channel 11 is an aggregation channel.

The control unit 620 may check an aggregation channel by reading information that a broadcast channel indicated by the broadcast channel is an aggregation channel from a predefined area of the transmission stream received through the broadcast channel. For instance, if the current broadcast channel is channel 11, the predefined area of the transmission stream received through the current broadcast channel may store information that the channel number 31 is an aggregation channel. Accordingly, the control unit 620 may read the information received from the broadcast channel 11 and confirm that the channel 31 is an aggregation channel.

In this case, a different channel may be set as an aggregation channel in each region. For instance, if there are 1 to 200 channels, and channel 10, channel 30, and channel 52 are set as an aggregation channel in regions A, B, and C respectively, the digital broadcast receiver 600 in region A scans channels 1 to 200 sequentially (if scanning is performed in the order of channel number) to check for an aggregation channel. In this case, whether the channel is an aggregation channel or not may be confirmed by using a value provided in the predefined area of an information channel such as TPC or FIC in the transmission stream or by identifying that information regarding an aggregation channel is inserted into the predefined area. In the above exemplary embodiment, the digital broadcast receiver 600 in region A scans channels 1 to 9 and confirms that an aggregation channel is channel 10. If the aggregation channel is confirmed, the control unit 620 instructs the reception unit 610 that it may stop scanning channels and control the reception unit 610 so that the reception unit 610 may select a broadcast channel using the access information provided by the confirmed aggregation channel.

If the reception unit 610 receives a stream from the selected aggregation channel, the received stream is processed by the demodulation unit 650, the equalizer 660, and the decoding unit 670 consecutively and the broadcast channel information is recovered.

If a user moves to the region B in this situation, the control unit 620 instructs the reception unit 610 to again perform auto-scanning from the beginning until channel 30 is selected and then search the selected aggregation channel.

If a broadcast service provider in each region is randomly selected or changed frequently, the digital broadcast receiver 600 may search for an aggregation channel by scanning broadcast channels directly as in the above exemplary description.

The information regarding the aggregation channel searched for through the above exemplary scanning process and the access information regarding the broadcast channel provided by the aggregation channel may be stored in the storage unit 630. Accordingly, if the user returns to the same region, the user may select an aggregation channel quickly using the information stored in the storage unit 630.

When a broadcast channel is selected using the access information provided by an aggregation channel in an exemplary embodiment, the information representing the broadcast channel such as a logo, a broadcast channel number and a broadcast channel name may be displayed on the display unit 640.

According to an exemplary embodiment, the digital broadcast receiver 600 may not display information representing a broadcast channel on the display unit 640 when selecting the broadcast channel using the access information provided by an aggregation channel. In this case, a broadcast channel with the lowest channel number or most frequently used broadcast channel may be automatically selected according to a predetermined method. In addition, a broadcast channel may also be automatically selected according to a predetermined method if a plurality of aggregation channels are identified.

The demodulation unit 650 may demodulate a transmission stream received through the selected broadcast channel. The demodulation unit 650 may perform demodulation operation such as carrier recovery (CR) for adjusting frequency and symbol timing recovery (STR) for adjusting symbol timing. The equalizer 660 may equalize the demodulated transmission stream. The decoding unit 670 may decode the equalized transmission stream. In this case, the control unit 620 may check the access information provided by the aggregation channel through the decoded transmission stream.

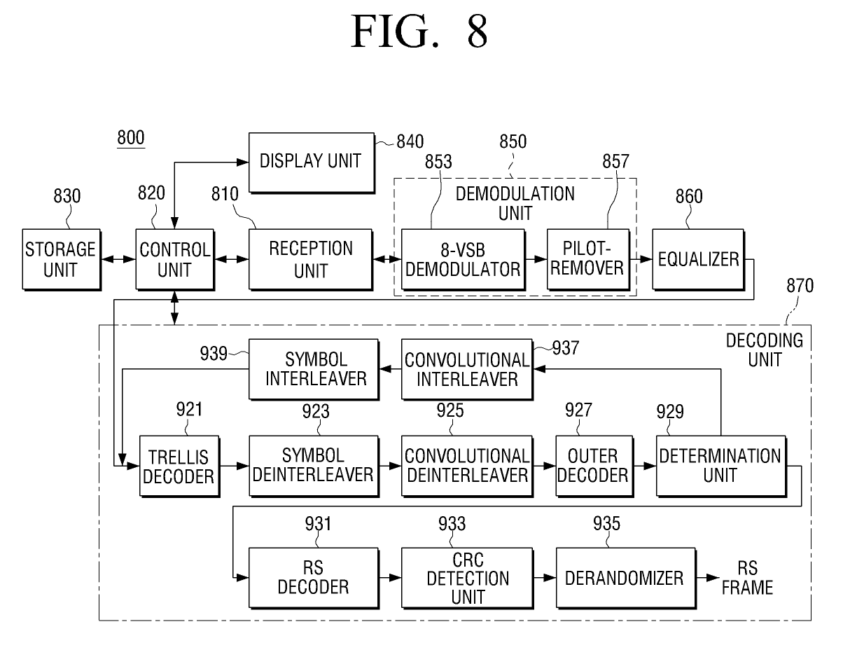

FIG. 8 is a view illustrating a digital broadcast receiver depicted in FIG. 7 in greater detail according to an exemplary embodiment. Since a reception unit 810, a control unit 820, a storage unit 830, a display unit 840, a demodulation unit 850, and an equalizer 860 are analogous to those of the digital broadcast receiver described with reference to FIG. 7, the detailed explanation of these elements will be omitted. However, the demodulation unit 850 may be divided into a 8-VSB demodulator 853 for performing CR and STR and a pilot remover 857 for removing a pilot signal.

FIG. 8 illustrates the decoding unit 870 in greater detail. The decoding unit 870 may include a trellis decoder 921, a symbol de-interleaver 923, a convolutional de-interleaver 925, an outer decoder 927, a determination unit 929, a RS decoder 931, a CRC detection unit 933, a de-randomizer 935, a convolutional interleaver 937, and a symbol interleaver 939. In addition, the control unit 820 may be connected to the decoding unit 870.

The trellis decoder 921 may decode a transmission stream including signaling data, audio data, and video data.

The symbol deinterleaver 923 may perform deinterleaving on the trellis decoded transmission stream, the convolutional deinterleaver 925 may perform convolutional deinterleaving on the deinterleaved transmission stream, and the outer decoder 927 may perform decoding to remove an added parity.

Subsequently, the determination unit 929 may output a soft decision and a hard decision. If a hard decision is output from the determination unit 929, the RS decoder 931 may perform Reed-Solomon decoding. If a soft decision is output from the determination unit 929, trellis decoding may be performed in the trellis decoder 921 after going through the convolutional interleaver 937 and the symbol interleaver 939. As such, trellis decoding operation is repeated until hard decision is output, and thus a reliable decoded value may be obtained. The determination unit 929 may be included in the outer decoder 927.

The CRC detection unit 933 may identify whether an error exists in the transmission stream which is RS-decoded after hard decision is output by the determination unit 929, and the transmission stream may be de-randomized in the de-randomizer 935 and an RS frame may be output. The CRC detection unit 933 may be included in the RS decoder 931.

The digital broadcast receiver 800 may further include a signaling decoding unit (not shown) connected to the decoding unit 870 in parallel. Of course, the decoding unit 870 may decode the stream output from the equalizer 860, signaling data except for TPC data and FIC data, audio data, and video data. The signaling decoding unit (not shown) may decode TPC data and FIC data among signaling data. A sync de-multiplexer (not shown) which de-multiplexing the stream output from the equalizer 860 into one of the decoding unit 870 and the signaling decoding unit (not shown) may be further included. Since the signaling decoding unit (not shown) decodes signaling data, the signaling data can be decoded to be robust against errors.

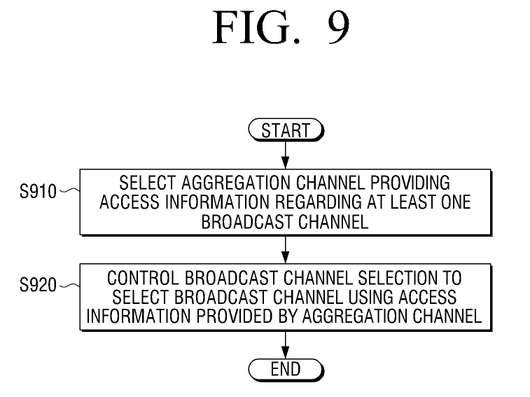

FIG. 9 is a flow chart illustrating a receiving method of a digital broadcast receiver according to an exemplary embodiment. Referring to FIG. 9, the receiving method of a digital broadcast receiver includes selecting an aggregation channel that provides access information of at least one broadcast channel from the reception unit 610 (S910) and controlling the control unit 620, 820 to select a broadcast channel using the access information provided by the aggregation channel.

In the controlling operation (S920), the control unit 620, 820 scans available broadcast channels, stops scanning if an aggregation channel is identified, and selects a broadcast channel using the access information provided by the identified aggregation channel.

The receiving method of a digital broadcast receiver may further include an operation in which the storage unit 630, 830 stores an aggregation channel having a different channel number for each region (not shown). In this case, in the controlling operation (S920), the control unit 620, 820 may access an aggregation channel corresponding to the region using the stored aggregation channel number and select a broadcast channel using the access information of the aggregation channel.

The receiving method of a digital broadcast receiver may further include displaying information representing a broadcast channel on the display unit 640, 840.

According to the receiving method of a digital broadcast receiver, a transmission stream received through the selected broadcast channel may be demodulated, the demodulated transmission stream may be equalized, and the equalized transmission stream may be decoded. In the controlling operation (S920), the control unit 620, 820 may check the access information provided by the aggregation channel through the decoded transmission stream.

The digital broadcast receiver according to an exemplary embodiment may be manufacture in an IC chip format. As described above, the digital broadcast receiver may include a computer reading and recoding medium including a program to perform the receiving method of the digital broadcast receiver. The computer reading and recording medium includes all kinds of recording apparatuses that store data readable by a computer system, and examples include a ROM, a RAM, a CD-ROM, a magnetic tape, a floppy disk, and a optical data storage apparatus. The computer reading and recording medium is distributed to a computer system connected through a network and a code that the computer may read through a variance method may be stored and executed.

Although a few exemplary embodiments have been shown and described, it would be appreciated by those skilled in the art that changes may be made in exemplary embodiments without departing from the principles and spirit of the invention, the scope of which is defined in the claims and their equivalents.

What is claimed is:

1. A digital broadcast receiver comprising:
a reception unit which selects an aggregation channel that provides access information regarding at least one broadcast channel; and
a control unit which controls the reception unit to select a broadcast channel from the at least one broadcast channel based on the access information provided by the aggregation channel.

2. The digital broadcast receiver as claimed in claim 1, wherein the access information is mapping information which maps information representing the broadcast channel to at least one physical frequency information accessible to the broadcast channel.

3. The digital broadcast receiver as claimed in claim 2, wherein the information representing the broadcast channel is at least one of a logo, a broadcast channel number, and a broadcast channel name.

4. The digital broadcast receiver as claimed in claim 1, wherein the aggregation channel is a predetermined channel having the same broadcast channel name in each region.

5. The digital broadcast receiver as claimed in claim 1, wherein the control unit controls the reception unit to scan available broadcast channels until the aggregation channel is identified and select the broadcast channel based on access information provided by the identified aggregation channel.

6. The digital broadcast receiver as claimed in claim 5, wherein the control unit reads information that the broadcast channel is an aggregation channel from a predefined area of a transmission stream and controls the reception unit to identify the aggregation channel based on the read information.

7. The digital broadcast receiver as claimed in claim 5, wherein the control unit reads information that another broadcast channel indicated by the broadcast channel is the aggregation channel from a predefined area of a transmission stream and confirms the aggregation channel.

8. The digital broadcast receiver as claimed in claim 1, further comprising:
a storage unit which stores the aggregation channel having a different broadcast channel number for each region,
wherein the control unit accesses the aggregation channel corresponding to a region based on the stored aggregation channel number and controls the reception unit to select the broadcast channel based on access information of the aggregation channel.

9. The digital broadcast receiver as claimed in claim 8, wherein, if it is determined that the aggregation channel for the region or the access information is changed, the control unit updates the aggregation channel for the region or the access information.

10. The digital broadcast receiver as claimed in claim 9, wherein the control unit reads information regarding whether an update has been performed from a predefined area of a transmission stream through which the aggregation channel is transmitted, and updates the aggregation channel or the access information.

11. The digital broadcast receiver as claimed in claim 1, further comprising:
a display unit which displays information representing the broadcast channel.

12. The digital broadcast receiver as claimed in claim 1, wherein if the digital broadcast receiver is turned on or if a handover of the digital broadcast receiver occurs, the reception unit selects the aggregation channel if a user inputs a command to select the aggregation channel.

13. The digital broadcast receiver as claimed in claim 1, further comprising:
a demodulation unit which demodulates a transmission stream received through the selected broadcast channel;
an equalizer which equalizes the demodulated transmission stream; and
a decoding unit which decodes the equalized transmission stream.

14. The digital broadcast receiver as claimed in claim 13, wherein the control unit identifies access information provided by the aggregation channel based on the decoded transmission stream.

15. A receiving method of a digital broadcast receiver, comprising:
selecting an aggregation channel having access information regarding at least one broadcast channel; and
controlling broadcast channel selection so that a broadcast channel from the at least one broadcast channel is selected based on access information provided by the aggregation channel.

16. The receiving method of a digital broadcast receiver as claimed in claim 15, wherein the access information is mapping information that maps information representing the broadcast channel to at least one physical frequency information accessible to the broadcast channel.

17. The receiving method of a digital broadcast receiver as claimed in claim 16, wherein the information representing the broadcast channel is at least one of a logo, a broadcast channel number, and a broadcast channel name.

18. The receiving method of a digital broadcast receiver as claimed in claim 15, wherein the aggregation channel is a channel that is preset to have the same broadcast channel number in each region.

19. The receiving method of a digital broadcast receiver as claimed in claim 15, wherein the controlling broadcast channel selection comprises scanning available broadcast channels, and if the aggregation channel is identified, stopping the scanning and selecting the broadcast channel based on the access information provided by the identified aggregation channel.

20. The receiving method of a digital broadcast receiver as claimed in claim 19, wherein the controlling broadcast channel selection comprises reading information that the broadcast channel is the aggregation channel from a predefined area of a transmission stream, and confirming that the read broadcast channel is the aggregation channel.

21. The receiving method of a digital broadcast receiver as claimed in claim 19, wherein the controlling broadcast channel selection comprises reading information that the broadcast channel indicated by the broadcast channel is the aggregation channel from a predefined area of a transmission stream, and confirming that the read broadcast channel is the aggregation channel.

22. The receiving method of a digital broadcast receiver as claimed in claim 15, further comprising:
storing the aggregation channel having a different broadcast channel for each region,
wherein the controlling broadcast channel selection comprises accessing the aggregation channel corresponding to a region using the stored aggregation channel number, and selecting the broadcast channel based on the access information of the aggregation channel.

23. The receiving method of a digital broadcast receiver as claimed in claim 22, wherein the controlling broadcast channel selection comprises if it is determined that an aggregation channel for the region or the access information is changed, updating the aggregation channel for the region or the access information.

24. The receiving method of a digital broadcast receiver as claimed in claim 23, wherein the controlling broadcast channel selection comprises reading information regarding whether an update has been performed from a predefined area of a transmission stream, and updating the aggregation channel or the access information.

25. The receiving method of a digital broadcast receiver as claimed in claim 15, further comprising:
displaying information representing the broadcast channel.

26. The receiving method of a digital broadcast receiver as claimed in claim 15, wherein the receiving comprises if a user inputs a command to select an aggregation channel and if the digital broadcast receiver is turned on or if a handover of the digital broadcast receiver occurs, selecting the aggregation channel.

27. The receiving method of a digital broadcast receiver as claimed in claim 15, further comprising:
demodulating a transmission stream received through the selected broadcast channel;
equalizing the demodulated transmission stream; and
decoding the equalized transmission stream.

28. The receiving method of a digital broadcast receiver as claimed in claim 27, wherein the controlling broadcast channel selection comprises identifying the access information provided by the aggregation channel provided in the decoded transmission stream.
